(19) United States
(12) Patent Application Publication
(10) Pub. No.: US 2009/0032503 A1
(43) Pub. Date: Feb. 5, 2009

(54) Thermal Cutting Method

(76) Inventor: Wolfgang DANZER, Dorfen (DE)

Correspondence Address: The BOC Group, Inc., 575 MOUNTAIN AVENUE, MURRAY HILL, NJ, 07974-2082, US

(21) Appl. No.: 12/172,416

(22) Filed: Jul. 14, 2008

(30) Foreign Application Priority Data
Jul. 26, 2007 (DE) 102007035403.9
Oct. 9, 2007 (EP) 07019760.3

(51) Int. Cl. B23K 9/00

(52) U.S. Cl. 219/121.44

(57) ABSTRACT

The invention pertains to a thermal cutting method, in which a cutting gas is introduced into a cutting nozzle and guided onto the work piece to be processed by means of the cutting nozzle, and in which the volumetric flow rate of the cutting gas is at least reduced in a periodically repeating fashion, wherein the invention is characterized in that the method is carried out with a periodicity that has a frequency between 700 Hz and 8000 Hz.

### CROSS REFERENCE TO RELATED APPLICATIONS

This application claims priority from German Patent Application Serial No. 102007035403.9, filed Jul. 26, 2007, and European Patent Application Serial No. 07019760.3, filed Oct. 9, 2007.

### BACKGROUND OF THE INVENTION

The present invention pertains to a thermal cutting method, in which a cutting gas is introduced into a cutting nozzle and guided onto the work piece to be processed by means of the cutting nozzle, wherein the volumetric flow rate of the cutting gas is at least reduced in a periodically repeating fashion.

Various thermal cutting methods are known. In thermal cutting, work pieces are cut by supplying energy to the location of the work piece to be cut such that material is removed from the work piece at the location to be processed. The material to be removed is expelled with the aid of the cutting gas jet.

Thermal cutting methods are contactless material processing methods and therefore have the advantage that the cutting tool is not subjected to any wear.

Thermal cutting methods are classified in accordance with the type of energy supply.

In flame cutting, the material is heated to the inflammation temperature with a fuel gas-oxygen flame or a fuel gas-air flame and burned in the cutting oxygen flow or in a cutting gas flow containing oxygen. The burning of the material in the cutting oxygen results in energy being supplied to the cutting process in addition to the flame. The kinetic energy of the oxygen jet is also used for expelling the cinder created due to the burning of the material and the molten material.

Plasma arc cutting primarily is a melting process, in which the base material is melted by the plasma arc and also evaporated. The term plasma arc refers to an ionized and dissociated gas jet that is constricted by a cooled nozzle. A plasma jet with high energy density is obtained due to the constriction. The base material is instantaneously melted in the kerf by the plasma jet and thrown out of the gap being created by the plasma gas. The cooling of the nozzle required for the constriction is usually realized either with water and/or with a secondary gas that envelops the plasma jet. The secondary gas flows around the plasma arc in the form of a gas envelope and additionally constricts the plasma arc such that the cutting quality and the cutting speed are improved. An adequate cutting performance is achieved with systems that also use a secondary gas as cooling gas. One variation of plasma cutting with a secondary gas is microjet plasma cutting, in which the plasma jet is highly constricted. In addition, it is possible to further constrict the plasma jet by means of additional water injection. The molten material is expelled due to the high kinetic energy of the plasma gas. If a secondary gas is used, this gas also blows out the liquid material. Argon, nitrogen, hydrogen and mixtures thereof are typically used as plasma gas. Oxygen is also added to the plasma gas in certain instances, wherein the oxygen can lead to oxidation with the material such that an additional energy input is realized. The gas may also consist of compressed air. Occasionally, carbon dioxide is also added. If a secondary gas is used, it also consists of one of the aforementioned gases or a mixture thereof. The gas used or the gas composition depends on the respective type of cutting method and, in particular, the thickness and the type of the material to be cut.

In laser beam cutting, a laser beam is used as the cutting tool. This is realized by pointing the laser beam at the desired location, wherein this is usually realized by focusing the laser beam on the surface of the work piece to be cut or in the interior of the work piece with the aid of a lens in the cutting head such that the material to be cut is rapidly heated due to the high energy density. In laser beam fusion cutting, the material is heated to the melting temperature, wherein the material is heated to the evaporation temperature in laser sublimation cutting. Laser beam cutting with oxygen is a technique in which oxygen is supplied to the location to be cut in order to input additional energy produced by burning the oxygen with the material analogous to flame cutting. To this end, the laser beam continuously heats the work piece to the inflammation temperature at the location being processed such that the work piece material can burn with the cutting oxygen. In laser beam cutting, the molten material is expelled from the kerf by the cutting gas, wherein the cutting oxygen jet also expels the cinder being produced in addition to the molten material in laser beam cutting with oxygen. In laser beam cutting with oxygen, the cutting gas consists of oxygen, wherein nitrogen, argon and/or helium are otherwise used as cutting gas in most instances. Compressed air is also used. A laser beam is an ideal tool for cutting thin metallic and non-metallic materials. However, the cutting speed of the laser beam decreases significantly as the material thickness increases. For example, sheet metal with a thickness of approximately two millimeters can be cut six-times faster than sheet metal with a thickness of approximately fifteen millimeters by means of laser beam cutting with oxygen.

In laser beam cutting, the cutting speed can be increased by supplying the cutting gas in a turbulent flow. For example, publication DE 43 36 010 A1 discloses a laser cutting device, in which a primary auxiliary gas and a secondary auxiliary gas are supplied by means of a processing head in such a way that the overall gas flow is in a turbulent flow state. It is also known from DE 10 2004 052 323 A1 that the cutting speed or the sheet metal thickness to be cut can be increased with a modulated movement of the cutting head. This can also be achieved with a modulation of the laser power and the gas pressure that is not described in detail. Publication DE 10 2005 049 010 A1 discloses a laser beam cutting method, in which a pressure modulation of the cutting gas flow is realized by using sound waves or an electric gas discharge.

With respect to plasma cutting, it is known from SU 1683927 to pulse the plasma jet by changing the electric current used for producing the plasma arc. It is furthermore known from GB 2194190 to modulate a supersonic plasma jet in such a way that a perforation can be cut or welded. To this end, the energy density alternately lies above and below the cutting or welding threshold, respectively. This is realized with a modulation of the gas flow or a modulation of the electric power for operating the plasma arc.

With respect to flame cutting, publication DE 101 48 168 A1 discloses a method, in which the cutting gas flows turbulently in the kerf. In this case, the turbulence of the gas flow is realized by means of pulsing with a valve or by means of another discontinuous gas flow. Document SU 812461 discloses pulsed secondary oxygen flows that are added to a primary oxygen flow at a certain angle in a flame cutting method. Document EP 533 387 A2 describes a device and a method for oxygen cutting, particularly for laser cutting with oxygen, in which an auxiliary gas is supplied to the cutting device in the form of gas pulses.

### BRIEF SUMMARY OF THE INVENTION

The present invention is based on the objective of making available a thermal cutting method that is improved with respect to the cutting quality and the stability of the cutting process, particularly also at high cutting speeds and when cutting thick sheet metals.

### DETAILED DESCRIPTION OF THE INVENTION

This objective is attained in that the method is carried out with a periodicity that has a frequency in the range between 800 Hz and 8000 Hz. The high frequency is particularly advantageous for the periodic repetition. It was determined that the present invention makes it possible to significantly improve the quality of the cuts and the cutting edges in comparison with the state of the art. The process stability and the reproducibility of the method are additionally increased. The expulsion of the liquid metal from the kerf takes place more efficiently, evenly and thoroughly than in the known methods. These improvements of the method respectively make it possible to further increase the cutting speed without sacrificing the quality or to improve the quality with an unchanged cutting speed.

The change of the volumetric flow rate of the cutting gas is advantageously carried out in such a way that a standing, oscillating pressure column is created. The standing, oscillating pressure column that represents a standing wave has particularly advantageous effects on the thermal cutting process and makes it possible to realize an optimal pressure distribution and an increased transmission of energy onto the work piece. The pressure column being created is pushed through the kerf during the cutting process. This represents a significant improvement in comparison with the known methods.

According to one preferred embodiment of the invention, the cutting gas is switched off in a periodically repeating fashion upstream of or in the cutting nozzle.

The process of periodically switching the cutting gas off and on represents the preferred embodiment of the invention. However, the advantages of the invention also clearly manifest themselves if the cutting gas is not switched off, but its amount is merely reduced. In this case, it suffices to reduce the cutting gas quantity by one-half or only by one-third. When the cutting gas is switched off or reduced, the cutting gas pressure drops at the location being processed. It is particularly advantageous that, according to the invention, the cutting gas pressure drops to values of approximately 10 to 50% of the initial cutting gas pressure and therefore represents the maximum value.

The periodic repetition of the change of the volumetric flow rate of the cutting gas with a high frequency in accordance with the invention proved advantageous for all thermal cutting methods. The thusly created pulsing improves the process of expelling the liquid metal in all these methods. In thermal cutting methods, in which work piece material burns in the cutting oxygen or in cutting gas containing oxygen, the expulsion of the cinder being formed is also promoted.

It is particularly advantageous to carry out the thermal cutting method by means of flame cutting and/or laser cutting, particularly laser cutting with oxygen and laser fusion cutting, and/or plasma cutting. Laser sublimation cutting can also be used.

According to one particularly advantageous additional development of the invention, the frequency for the periodic repetition lies between 1000 and 5000 Hz, preferably between 1200 and 3000 Hz, particularly between 1500 and 2000 Hz. Particularly good results were obtained in these ranges.

It is advantageous to reduce or switch off the cutting gas mechanically, preferably by means of at least one valve, particularly by means of a magnetic or piezoelectric valve. The cutting gas is preferably pulsed by means of at least one valve. Another option consists of pulsing by means of another gas flow that is occasionally switched on and added to the cutting gas flow. It is particularly advantageous to utilize a valve that can be controlled or adjusted in an infinitely variable fashion. Another option consists of correspondingly switching on at least one additional gas flow. It would also be conceivable to use a bypass.

According to one advantageous additional development of the invention, the composition of the cutting gas is also changed in a periodically repeating fashion.

It is particularly advantageous to change the volumetric flow rate and, if applicable, the composition of the cutting gas with a constant period.

It is particularly advantageous to carry out the change of the volumetric flow rate of the cutting gas with a constant amplitude change.

According to one particularly advantageous embodiment of the invention, the change of the volumetric flow rate and, if applicable, the composition of the cutting gas is realized in a periodic sequence that is repeated in unchanged fashion. The change of the volumetric flow rate of the gas can be at least partially illustrated as a function of the time, e.g., by a rectangular, triangular or sinusoidal profile or a combination thereof. The change of the composition, e.g., of a two-component process gas may assume any curve shapes, particularly also those mentioned above. In this case, it is important to distinguish illustrations, in which one component of the process gas is respectively plotted on the x-axis and the y-axis of the illustration, from illustrations, in which the components are plotted in the y-direction and the time is plotted in the x-direction.

In certain applications, it may be particularly advantageous to use a sequence that is periodically repeated in modified form.

The cutting gas used advantageously consists of oxygen, nitrogen, argon, hydrogen or a mixture that contains at least one gas of this group. Carbon dioxide is also used.

The advantages of the invention manifest themselves, in particular, when oxygen is used as the cutting gas in laser beam cutting, namely because the change of the volumetric flow rate creates a standing wave that influences, in particular, the formation of the oxide skin in the kerf and the cinder formation in a particularly advantageous fashion during laser cutting with the oxygen and the formation of the oxide skin impairs the cutting process, particularly in laser cutting with oxygen.

If a plasma torch with a plasma gas and a secondary gas is used in plasma cutting, it is possible to modulate the plasma gas, the secondary gas or both gas flows in accordance with the invention. However, the advantages of the invention manifest themselves in a particularly distinct fashion if only the secondary gas is modulated in accordance with the invention and the plasma gas flows against the work piece in an unchanged fashion during the cutting process. If a plasma torch without secondary gas is used, the plasma gas is varied in accordance with the invention.

When using oxygen as cutting gas, for example, the cutting oxygen can be switched off and switched on again in a periodically repeating fashion. This varies the volumetric flow rate of the oxygen supply. It is particularly advantageous to switch the oxygen flow off and on, e.g., with a piezoelectric valve that is designed for the preferred frequency ranges mentioned above.

According to another example, in which the cutting gas used consists of a mixture of nitrogen and oxygen, the cutting oxygen may, for example, be switched off or reduced in a periodically repeating fashion, i.e., the volumetric flow rate of the oxygen supply may be varied, such that the oxygen content of the cutting gas and therefore the composition of the cutting gas are changed. These processes can be further optimized by also varying the overall volumetric flow rate of the cutting gas.

We claim:

1. A thermal cutting method, in which a cutting gas is introduced into a cutting nozzle and guided onto the work piece to be processed by means of the cutting nozzle, wherein the volumetric flow rate of the cutting gas is at least reduced in a periodically repeating fashion, characterized in that the method is carried out with a periodicity that has a frequency between 700 Hz and 8000 Hz.

2. The method according to claim 1, characterized in that a standing, oscillating pressure column is created.

3. The method according to claim 1, characterized in that the cutting gas is switched off in a periodically repeating fashion upstream of or in the cutting nozzle.

4. The method according to claim 1, characterized in that the thermal cutting method is carried out by means selected from the group consisting of flame cutting, laser cutting with oxygen, laser fusion cutting, and plasma cutting.

5. The method according to claim 1, characterized in that the frequency for the periodic repetition lies between 1000 and 5000 Hz.

6. The method according to claim 5, characterized in that the frequency for the periodic repetition lies between 1200 and 3000 Hz.

7. The method according to claim 5, characterized in that the frequency for the periodic repetition lies between 1500 and 2000 Hz.

8. The method according to claim 1, characterized in that the cutting gas is reduced or switched off mechanically, preferably by means of at least one valve.

9. The method according to claim 8, characterized in that said at least one valve is selected from the group consisting of a magnetic valve and a piezoelectric valve.

10. The method according to claim 1, characterized in that the composition of the cutting gas is changed in a periodically repeating fashion.

11. The method according to claim 1, characterized in that the cutting gas used advantageously is selected from the group consisting of oxygen, nitrogen, argon, hydrogen or a mixture that contains at least one gas of this group.

12. The method according to claim 1, characterized in that oxygen is used as the cutting gas in laser beam cutting.

13. The method according to claim 1, characterized in that, when plasma cutting with a plasma torch with plasma gas and a secondary gas, only the secondary gas is at least reduced in a periodically repeating fashion.
